(19) United States
(12) Patent Application Publication
(10) Pub. No.: US 2011/0030392 A1
(43) Pub. Date: Feb. 10, 2011

(54) EXPANDER SPEED CONTROL

(75) Inventors: John Borchers, Allentown, PA (US); Gary Ash, Dartmouth, MA (US); Relph C. LongsWorth, Allentown, PA (US)

Correspondence Address: KATTEN MUCHIN ROSENMAN LLP, 575 MADISON AVENUE, NEW YORK, NY, 10022-2585, US

(73) Assignee: Sumitomo (SHI) Cryogenics of America, Inc, Allentown, PA (US)

(21) Appl. No.: 12/279,668

(22) PCT Filed: Dec. 13, 2007
(86) PCT No.: PCT/US07/87409

§ 371 Date: Oct. 25, 2010

Related U.S. Application Data
(60) Provisional application No. 60/898,061, filed on Jan. 29, 2007.

(51) Int. Cl. B01D 8/00; F04B 49/06

(52) U.S. Cl. 62/55.5; 417/44.1

(57) ABSTRACT

Apparatus and method for controlling the speed for a GM type expander includes relays that interrupt power when the current in the line is zero. The speed controller apparatus limits the maximum speed providing the expander with sufficient gas to meet its cooling requirements.

### FIELD OF THE INVENTION

This invention relates to an apparatus and method to control the speed of a GM type expander, and more particularly, an apparatus and method to control the operational speed of a GM type expander motor within a cryopump.

### BACKGROUND OF THE INVENTION

A Gifford McMahon (GM) cryogenic refrigerator typically consists of a compressor operating at 50 or 60 Hz connected by gas lines to an expander that is operating at less than 2.4 Hz. Displex® expanders (manufactured by SHI Cryogenics) use a synchronous motor that operates at 1 Hz on 50 Hz power and 1.2 Hz on 60 Hz power. The motor maintains a constant rotating speed of a valve disc under varying load conditions. The pneumatic drive mechanism has a rotating valve disc that is double ported. That is, there are two refrigeration cycles per revolution of the valve disc. GM expanders fall into two broad categories, those that have mechanical drives, and those that have pneumatic drives. In a mechanical drive unit the motor is connected to a linkage that moves the displacer up and down and actuates gas inlet and outlet valves while in a pneumatic drive the moter turns a valve that ports gas to drive the displacer and admit and return gas from/to a compressor. A cryopump can be a one or two stage unit. Two stage units are used to remove all gases from a vacuum chamber. Most cryopumps use two stage GM type expanders to cool the cryopanels. Some cryopumps have speed controllers to adjust the speed for several different purposes. Speed controllers have only been applied to mechanical drive expanders because the valve timing is coordinated with the displacer motion mechanically, while in a pneumatically driven unit the valve timing is decoupled from the displacer motion except at the design speed.

The most common means of changing the speed of the drive motor is by rectifying the AC current that is supplied, then using solid state devices to approximate an AC wave pattern at a different frequency. These frequency converters tend to emit significant radio frequency (RF) interference, and are large and costly. Several patents disclose speed controllers.

U.S. Pat. No. 5,386,708 to Kishorenath, et al. contains a description of GM cycle refrigerators and reasons for speed control to be used. These include, to control either the first or second stage temperature which must be within certain limits for proper operation, to increase speed during cool down to cool down faster, and as in the '708 patent, to reduce vibration or natural resonance frequency of the expander.

U.S. Pat. No. 5,582,017 to Noji, et al. describes the use of speed control as part of a means to minimize regeneration time.

U.S. Pat. No. 5,775,109 to Eacobacci, et al. describes speed control during cool down of multiple pumps as a means of having them cool down at the same rate. This speed control uses a common helium supply manifold which frequently supplies more helium than required by the cryopump. The effect is increased time required for cool down, causing the cryopump refrigerator to become colder than needed, wasting power and other resources

U.S. Pat. No. 6,655,154 to Funayama, et al. describes the use of speed control for multiple expanders operating from a common compressor as a means to avoid having them run in phase.

U.S. Pat. No. 7,127,901 to Dresens, et al. describes another use of speed control when operating multiple cryopumps by having them share gas from a common helium supply manifold in a way that enables each cryopump to meet its functional requirements.

All of the expanders described in the above prior references have mechanical drives and frequency converters. That is, the expanders have motor and frequency conversion type speed controllers that have the disadvantage of radiating RF noise. In view of the drawbacks of the above speed controllers, a need exists for speed controllers which minimize RF noise to achieve the benefits of reducing system power output, vibrations, and the amount of gas that is used. The present invention fills that technology gap.

### SUMMARY OF THE INVENTION

It is an object of the present invention to avoid the generation of RF noise of previous speed controllers and provide a speed control which allows a cryopump to run at the minimum speed necessary to be cold, in order to minimize system power input, and to limit the maximum speed to limit the maximum amount of gas that is used by one of several cryopumps that are operating from a common compressor.

It is also an object of the present invention to provide multiple GM type expanders connected to a common compressor wherein said controller limits the maximum speed so that each expander has sufficient gas to meet its cooling requirements.

As used herein, the term “sufficient gas” refers to the ability of a cryopump to meet its functional requirements.

As used herein, the term “operational speed” refers to the speed of the revolution of the drive motor.

It is a primary objective of the present invention to prevent RF noise while at the same time reducing the cost of controlling the speed. The speed of an AC synchronous motor is reduced below the speed it would run at with 50 or 60 Hz input power by using solid state relay switches that open and close when the current flowing through them is zero. This avoids the emission of any RF noise and reduces the average motor speed by starting and stopping the motor. The synchronous motor that is used operates at 1 Hz on 50 Hz power and 1.2 Hz on 60 Hz power, and can stop and start in about 22 ms. It has been found that after the motor is turned off that vibration is minimized if the motor is left off for about 66 ms. It can subsequently be turned on for whatever period of time is needed to achieve the desired average rotational speed. The preferred “on” time is equal to at least three times the time it takes for the motor to stop. Stopping the drive motor when the inlet and outlet valves are closed produces only a small effect on the flow per cycle and the refrigeration that is produced. Stopping when one of the valves is open results in more gas flowing into the expander relative to the refrigeration that is produced. The motor that is used has markings on the end of the shaft that can be read by an encoder so that it is practical to include in the logic that determines when to stop the motor to have it stop when the valves are closed. The advantage of stopping the motor when the valves are closed applies to both pneumatic and mechanical drives.

In another aspect of the invention, other means of determining the motor orientation relative to the position of the displacer and valves include markings on the valve disc that are read optically, monitoring the temperature cycle at the cold end, and includes logic in the speed controller that notes when the temperature drops for a given timing then locks into that timing until the cooling load changes.

The present implementation of this invention is also directed to a control unit which stops the drive motor at random times relative to the position of the valve but the advantages of reducing the speed when cooling a cryopump are much greater than the increase in thermal losses per cycle. This method of controlling the average rotational speed reduces the RF interference relative to the use of frequency converters and is smaller and less expensive. In the present invention speed control is used to set an upper limit on the amount of gas that can be used by one of several expanders that are connected to a common compressor.

The present invention also comprises a refrigeration apparatus including the speed controlling apparatus described above.

These novel features of the present invention will become apparent to those skilled in the art from the following detailed description, which is simply, by way of illustration, various modes contemplated for carrying out the invention. As will be realized, the invention is capable of additional, different obvious aspects, all without departing from the invention. Accordingly, the figures and the specification are illustrative in nature and not restrictive.

### BRIEF DESCRIPTION OF THE DRAWINGS

FIG. 1 is a schematic diagram of the relationship of a host computer, a cryopump controller and a cryopump.

FIG. 2 is a schematic diagram of the main components in the cryopump controller that control the expander speed.

FIG. 3 is an illustration of a Displex® expander that shows the AC synchronous motor that drives a rotary valve disc.

### DETAILED DESCRIPTION OF THE INVENTION

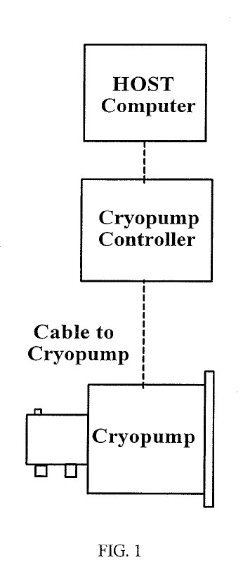

In FIG. 1 the relationship of a host computer, a cryopump controller and a cryopump is detailed. Cryopumps are frequently used on vacuum chambers that are used to produce semiconductor devices. A host computer controls the manufacturing process, monitors the status of one or more cryopumps, and sends signals to the cryopump controller when to start, stop, and regenerate the cryopumps. The cryopump controller has a microprocessor that communicates with the host computer and receives signals from the sensors on the cryopump. The microprocessor sends signals to devices in the cryopump controller that switch power to valves, heaters, etc. on the cryopump.

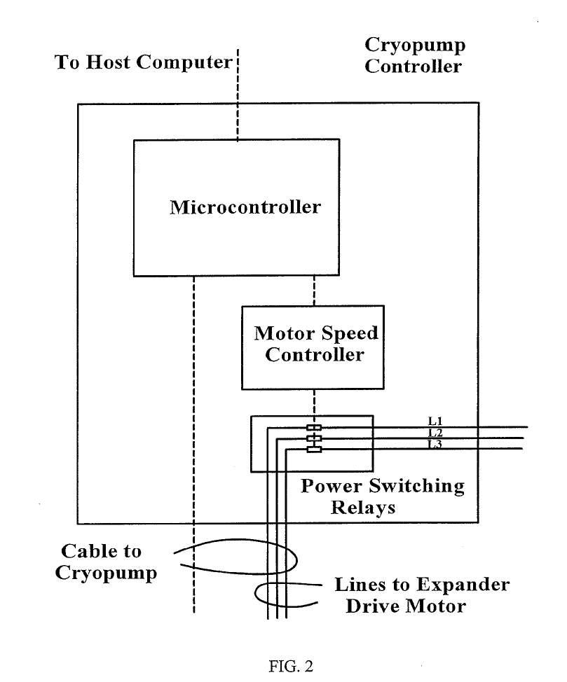

FIG. 2 is a schematic that shows the main components in the cryopump controller that control the speed of the expander. The cryopump controller has a microprocessor that performs logic operations related to the control of the cryopump and sends signals to devices such as a motor speed controller that in turn actuates power switching relays that control power to the drive motor. In a preferred embodiment, the microprocessor is Motorola HCS 12A, and the three power switching relays are Crydom CX240D5, a model that turns the power off and on when the current is zero. Similar devices are available from other manufacturers. The microcontroller has logic that sets an expander speed based on controlling either the first stage or second stage temperature and sends a signal to the motor speed controller to adjust the speed. The motor speed controller is preset to turn the motor on in increments of 22 ms. The number of increments that are used is set locally. The time that the motor is off is set by the signal that turns the motor on. Three power lines to the expander drive motor provide current that is out of phase. The power lines are switched sequentially by three relays. The present system controls the speed on a cycle that has 23 time increments of 22 ms (22.222 to be more precise) or a total of 511 ms. In order to set a minimal rotational speed, the motor is on for at least 4 increments or 89 ms out of the possible 511 ms. The present motor operates with 200 steps per revolution so it is also possible to control on the basis of the number of steps that are taken rather than time.

RF radiation creates a voltage at the terminals of a pickup coil or an antenna external to the switch box. Examples of instruments that can be used to measure RFI are 1) National Instruments Model NI PXI-5660 and 2) Magnetic Sciences series EMC-100 magnetic field probes (magneticsciences.com). It is understood that alternative devices, other than the microcontroller, can send an equivalent signal to the motor speed controller.

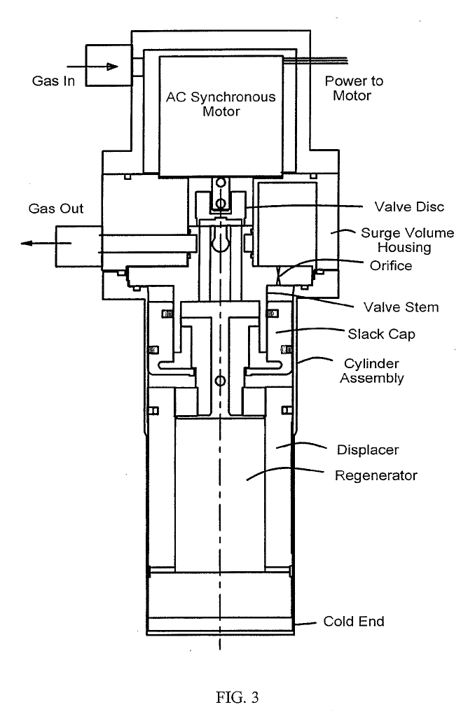

Advantageously, according to a preferred embodiment of the method and apparatus according to the invention, the AC synchronous motor is a three phase AC synchronous motor such as, but not limited to, type SS422 (Superior Electric). The AC synchronous motor is a stepping type motor equivalent to the one that is used. Principals of operation can be found in the manufacturers' literature which is incorporated by reference herein. FIG. 3 is an illustration of a Displex® expander that shows the AC synchronous motor, Superior Electric SS242 in the present system, that drives a rotary valve disc. The motor is contained in a housing that has an electrical feed-through and an inlet gas fitting. The valve disc rotates over ports in a valve stem that cycle gas (helium) through a regenerator in a displacer to an expansion space at the cold end of a cylinder assembly where refrigeration is produced. The displacer is pulled up and pushed down by a slack cap that is driven by gas flowing in and out of a surge volume through an orifice. Gas flows back to a compressor through an outlet gas fitting.

While the present invention is used with a GM type cryogenic refrigerator, it is understood that the speed control of the present invention can be used with a plurality of cryogenic refrigerators or a pulse tube refrigerator or any cryopump having an expander that is subject to expander speed control.

What is claimed is:

1. A method for a controlling the operating speed of at least one GM type expander that is driven by an AC synchronous motor comprising:
interrupting power when the current in the line is zero by relays.

2. The method of claim 1, wherein the power interruption is such that the power is on for at least three times the time it takes for the motor to stop.

3. The method of claim 1, further comprising: stopping the drive motor when the valves of the GM type expander are in a closed position.

4. The method of claim 1 further comprising multiple GM type expanders connected to a common compressor wherein said controller limits the maximum speed so that each expander has sufficient gas to meet its cooling requirements.

5. A cryopump comprising:
at least one GM type expander driven by an AC synchronous motor;
a controlling means that limits the maximum speed so that each expander has sufficient gas to meet its cooling requirements;
and wherein said controlling means interrupts power when the current in the line is zero by relays.
